(19) United States
(12) Patent Application Publication
(10) Pub. No.: US 2006/0135261 A1
(43) Pub. Date: Jun. 22, 2006

(54) System, game server, terminal, and method for clan presence in a multiplayer game

(75) Inventors: Jason Kinne, Pacifica, CA (US); John Kuner, San Francisco, CA (US); Sally Vedros, San Francisco, CA (US); Peter Decker, Marl (DE)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/057,428

(22) Filed: Feb. 14, 2005

Related U.S. Application Data
(63) Continuation of application No. 11/015,389, filed on Dec. 17, 2004.

(51) Int. Cl. G06F 17/00; G06F 19/00

(52) U.S. Cl. 463/42

(57) ABSTRACT

A system, game server, terminal, and method allow a player of a multiplayer game to quickly determine the presence status of the player's online gaming clan without determining the status of each clan member individually. The system determines the presence status of a clan based on the presence status of the gaming devices associated with the clan. The system continuously communicates with the gaming devices to monitor the presence status of all clan members. A member of a clan maybe designated as a clan administrator. The clan administrator may interface with the game server to set presence rules for the player's clan.

### CROSS REFERENCE TO RELATED APPLICATIONS

This application is a continuation of U.S. application Ser. No. 11/015,389, filed Dec. 17, 2004, which is hereby incorporated herein in its entirety by reference.

### FIELD OF THE INVENTION

The present invention generally relates to systems and methods of operating a multiplayer game and, more particularly, relates to systems and methods of monitoring clan presence in multiplayer games.

### BACKGROUND OF THE INVENTION

Multiplayer gaming is a popular pastime, and it continues to grow in popularity as more devices, particularly mobile devices, are created to facilitate this type of gaming. Multiplayer gaming initially only involved using personal computers connected via a wired interface to a network, such as the Internet. As wireless networks and wireless Internet access became more prevalent, multiplayer gaming took advantage of this wireless capability. Cellular telephones and other mobile electronic devices connected via wireless networks began offering gaming. Additionally, dedicated wireless mobile gaming devices were created. These wireless mobile gaming devices allow users to participate in multiplayer gaming away from their personal computer and wired network connection. For purposes of this application, the term “gaming device” will be used to refer to all devices capable of gaming over a network, whether the device is a personal computer, a cellular telephone, a mobile gaming device, or any other type of device, whether the network is the Internet, a cellular telephone network, or any other type of network, and whether the communication with the network is wired or wireless.

A feature of many mobile electronic communication devices is presence enabling, which allows users of these devices to determine whether other users are online and available for communication. Presence enabling is available to a certain extent in multiplayer gaming systems. Presence enabling provides status information for a player to other players of the gaming system. This status information tells other players whether a particular player is able to play a game at this particular time. This status information may vary according to the type of gaming device. For example, for a personal computer with a wired Internet connection, the status information may include whether the player is online and whether the player is currently participating in a particular game. For cellular telephones or other mobile devices, the status information may include the user's geographic location and the latency of the network to which the mobile device is connected. Presence enabling has been extended to provide availability status. Availability status information may include whether the user is in a meeting, out of the office, or on vacation, for example. Availability status may be input by the user into the device, or the device may interface with the user's online calendar to obtain the player's availability status. While being able to access another user's presence and availability status is helpful, it requires connecting to the network to view another user's status.

In multiplayer gaming, games may be played by one player against one other player, by several players who each play individually against all the other players, or by teams of players who play against other teams of players. These teams are commonly referred to as clans. Presence enabling allows a player to determine if other members of the player's clan are online and available to play. However, this requires the player to check the presence status of the player's clan members individually. This can be time consuming and requires multiple interactions with the gaming device.

In multiplayer gaming, particularly using mobile gaming devices, when a player finishes playing, the player may disconnect from the gaming system by logging off. This is done for two reasons. The player may be connected to a gaming system that charges a fee based on how long the player is connected to the gaming system. Additionally, the mobile gaming device may consume more battery power when it is connected to the gaming system. The problem with logging off the gaming system is that other players may connect to the gaming system looking to play during the time the player is logged off. There is no way for the player to learn that other players are online, unless the player goes back online to check. This method of going back online just to check availability of other players is time consuming and may result in the player connecting to the gaming system numerous times yet not finding other players online and available to play. In addition to checking online availability of other players, there are other reasons a player might need to repeatedly connect to the gaming system. If the player is participating in a persistent game (generally a role-playing game in which the overall goal is to refine and improve the player's character), the player may connect to the gaming system repeatedly to check the status of the game and of the player's, or another player's, character. Again, this is time consuming, and the player may go to the effort of connecting to the gaming system just to determine that there is no status change since the last time the player connected.

Note that with a mobile device that features communication capability as well as gaming, such as a cellular telephone, the player may log off the gaming system yet remain connected to a communication network to be able to receive communication messages and phone calls. For example, the player may be playing a multiplayer game using a cellular telephone. While the player is playing the game, the cellular telephone is typically connected to the gaming system and to the communication system. Being connected to both the gaming system and the communication system allows the player to receive communication messages and phone calls while playing. These messages and phone calls may or may not be related to the game being played. When the player stops playing the game, the player will typically disconnect from the gaming system. The player will disconnect from the gaming system because generally the cellular service provider charges the player for the time the player is connected to the gaming system. Additionally, when the cellular telephone is connected to the gaming system it will generally consume more battery power than when it is not connected to the gaming system. Even when disconnected from the gaming system, however, the player will typically remain connected to the communication network so the player can continue to receive communication messages and phone calls. While the player is disconnected from the gaming system and connected to the communication network, the player is unable to determine the presence status of other players, such as when other players begin playing a game, without reconnecting to the gaming system. The player is also unable to determine the status of a game, or the status of the player's character in a persistent game, without reconnecting to the gaming system.

As such, there is a need for a method and system to provide notification of events to players of a multiplayer gaming system, and to facilitate determination of clan presence on a multiplayer gaming system.

### BRIEF SUMMARY OF THE INVENTION

A system, game server, terminal, and method are therefore provided that allow a player of a multiplayer game to receive notification of events while the player is not playing the game and that allow a player to quickly determine the presence status of a gaming clan. In accordance with embodiments of the present invention, the game event notification system may comprise a client or terminal, such as a gaming device, and a game server. The gaming device will typically have a processor capable of executing a thin application as well as a client-side game application. The game server will typically have a processor capable of executing a server-side game application.

The thin application, called an event notification client, maintains a minimal communication connection to the game server, thereby reducing communication costs and power consumption. By maintaining this minimal communication connection, the game event notification system is able to provide notification to the player even when the player is not executing the client-side gaming application. The event notification client generally runs in the background on the gaming device and is not visible to the player. In one embodiment, the thin application is a separate software program from the client-side gaming application. In another embodiment, the thin application is a portion of the client-side gaming application, such as a software program sub-routine. In this embodiment, the entire client-side gaming application would typically execute when a player is playing the multiplayer game. However, when the player is not playing the multiplayer game, only the portion of the client-side gaming application that comprises the thin application (i.e., the portion that maintains the minimal communication connection) would typically be executing.

The game event notification system allows a player to subscribe to the notification system, with the player's subscription preferences stored in the event subscription database. This subscription allows the player to specify what type of events will trigger a notification. For example, the player can specify in the subscription that the player will be notified when a particular other player connects to the gaming system or begins playing a particular game, when a particular other player's presence status changes, or when the status of a persistent game changes.

The game event notification system monitors events within or external to the gaming system. When a particular event occurs, the game event notification system communicates with the event subscription database to determine which gaming devices belonging to which players should receive notification of the event. After the game event notification system determines which players to notify, the system may transmit predefined messages to the appropriate gaming devices. The messages are received by the gaming device which displays the message on a display portion. Depending upon preferences set by the player and the capabilities of the device, the gaming device, in addition to or instead of providing a visual display of the message, may provide an audio alert, such as beeping or polyphonic tones, or may provide a tactile alert, such a vibration.

When the gaming device receives the notification, in addition to displaying the message and providing an alert, the gaming device may cause the gaming application to start, either automatically or upon confirmation by the player, and may start a specific game that was the subject of the notification.

A clan presence system allows a player to quickly determine the presence status of a gaming clan, without determining the status of each clan member individually. In accordance with embodiments of the present invention, the clan presence system comprises a game server and a number of clients or terminals, such as gaming devices. The game server determines the presence status of a clan based on the presence status of the gaming devices associated with the clan.

A member of a clan maybe designated as a clan administrator. The clan administrator may interface with the game server to set presence rules for the player's clan. The presence rules may include which players are members of the clan, which players are eligible to be leader of the clan during gaming, and what minimum number of clan members is required to play a particular game. The clan presence rules may also include what conditions must be present for the clan presence status to be displayed as online or available, such that some or all players can see that the clan is available to play. The conditions may include that an eligible team leader and the minimum number of clan members are online. The conditions may include that a minimum number of clan members are within a particular vicinity or connected via a particular bearer service, thus ensuring a sufficiently low latency of the clan members' communication connection.

The game server continuously communicates with the gaming devices to monitor the presence status of all clan members. The game server determines the presence status of all clans and communicates with the gaming devices, such that the presence status of any player or any clan may be communicated to the gaming device and displayed for the player to view. The communication between the game server and the gaming device may be automatic, in that the current presence status of predetermined players and clans may be routinely sent to specific gaming devices, or it may be ad hoc, in that a player may conduct a transaction on the gaming device to request current presence status of a player or clan.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a block diagram of one type of system that would benefit from embodiments of the present invention;

FIG. 2 is a schematic block diagram of an entity capable of operating as a mobile station, game server, proxy server, personal computer (PC) system, and/or game console, in accordance with embodiments of the present invention;

FIG. 3 is a schematic block diagram more particularly illustrating a mobile station in accordance with one embodiment of the present invention;

FIG. 4 is a schematic block diagram of an exemplar configuration of various network entities of the system of FIG. 1, in accordance with one embodiment of the present invention;

FIG. 5 is a schematic block diagram of an exemplar configuration of a game event notification system, in accordance with one embodiment of the present invention;

FIG. 6 is a schematic block diagram of an exemplar configuration of a clan presence system, in accordance with one embodiment of the present invention;

FIG. 7 is an illustration of clan data input to a clan presence system, in accordance with one embodiment of the present invention; and

FIG. 8 is an illustration of clan presence information output to a gaming device, in accordance with one embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

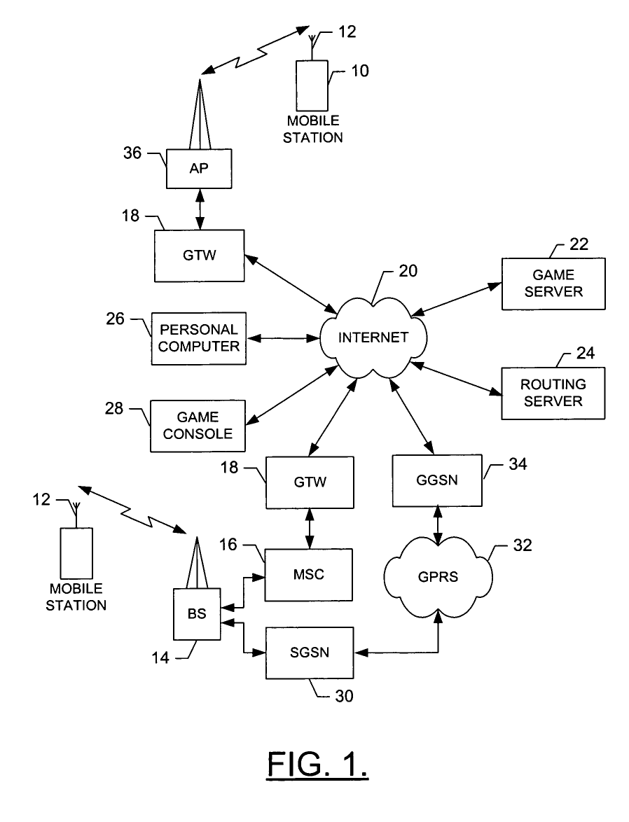

Referring to FIG. 1, an illustration of one type of system that would benefit from the present invention is provided. The system can include one or more mobile stations 10, each having an antenna 12 for transmitting signals to and for receiving signals from one or more base stations (BS's) 14. The base station is a part of one or more cellular or mobile networks that each includes elements required to operate the network, such as one or more mobile switching centers (MSC) 16. As well known to those skilled in the art, the mobile network may also be referred to as a Base Station/MSC/Interworking function (BMI). In operation, the MSC is capable of routing calls, data or the like to and from mobile stations when those mobile stations are making and receiving calls, data or the like. The MSC can also provide a connection to landline trunks when mobile stations are involved in a call.

The MSC 16 can be coupled to a data network, such as a local area network (LAN), a metropolitan area network (MAN), and/or a wide area network (WAN). The MSC can be directly coupled to the data network. In one typical embodiment, however, the MSC is coupled to a gateway (GTW) 18, and the GTW is coupled to a WAN, such as the Internet 20. In turn, devices such as processing elements (e.g., personal computers, server computers or the like) can be coupled to the mobile station 10 via the Internet. For example, as explained below, the processing elements can include one or more processing elements associated with one or more game servers 22, routing servers 24, personal computer (PC) systems 26, game consoles 28, or the like, one of each being illustrated in FIG. 1 and described below. As will be appreciated, the processing elements can comprise any of a number of processing devices, systems or the like capable of operating in accordance with embodiments of the present invention.

The BS 14 can also be coupled to a signaling GPRS (General Packet Radio Service) support node (SGSN) 30. As known to those skilled in the art, the SGSN is typically capable of performing functions similar to the MSC 16 for packet switched services. The SGSN, like the MSC, can be coupled to a data network, such as the Internet 20. The SGSN can be directly coupled to the data network. In a more typical embodiment, however, the SGSN is coupled to a packet-switched core network, such as a GPRS core network 32. The packet-switched core network is then coupled to another GTW, such as a GTW GPRS support node (GGSN) 34, and the GGSN is coupled to the Internet.

Although not every element of every possible network is shown and described herein, it should be appreciated that the mobile station 10 may be coupled to one or more of any of a number of different networks. In this regard, mobile network(s) can be capable of supporting communication in accordance with any one or more of a number of first-generation (1G), second-generation (2G), 2.5G and/or third-generation (3G) mobile communication protocols or the like. More particularly, one or more mobile stations may be coupled to one or more networks capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. In addition, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

One or more mobile stations 10 can further be coupled to one or more wireless access points (APs) 36. The AP's can be configured to communicate with the mobile station in accordance with techniques such as, for example, radio frequency (RF), Bluetooth (BT), infrared (IrDA) or any of a number of different wireless networking techniques, including WLAN techniques. The APs may be coupled to the Internet 20. Like with the MSC 14, the AP's can be directly coupled to the Internet. In one embodiment, however, the APs are indirectly coupled to the Internet via a GTW 18. As will be appreciated, by directly or indirectly connecting the mobile stations and the user processors (e.g., game servers 22, routing servers 24, personal computer (PC) systems 26, game consoles 28) and/or any of a number of other devices to the Internet, whether via the AP's or the mobile network(s), the mobile stations and user processors can communicate with one another to thereby carry out various functions of the respective entities, such as to transmit and/or receive data, content or the like. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of the present invention.

Although not shown in FIG. 1, in addition to or in lieu of coupling the mobile stations 10 to game servers 22, routing servers 24, personal computer (PC) systems 26 and/or game consoles 28 across the Internet 20, one or more such entities may be directly coupled to one another. As such, one or more network entities may communicate with one another in accordance with, for example, RF, BT, IrDA or any of a number of different wireline or wireless communication techniques, including LAN and/or WLAN techniques.

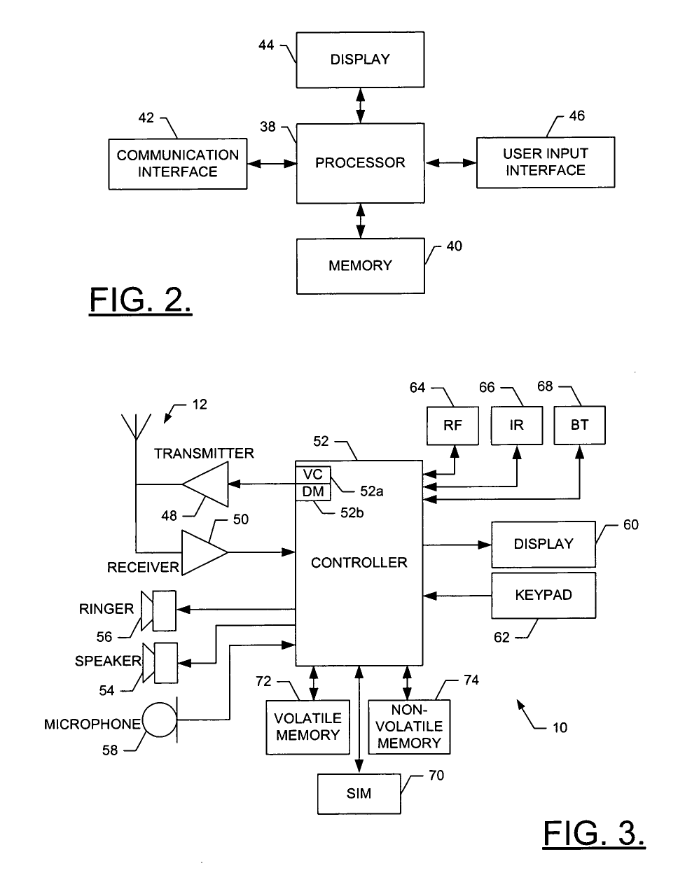

Referring now to FIG. 2, a block diagram of an entity capable of operating as a mobile station 10, game server 22, routing server 24, personal computer (PC) system 26 and/or game console 28, is shown in accordance with one embodiment of the present invention. Although shown as separate entities, in some embodiments, one or more entities may support one or more of a mobile station, game server, routing server, personal computer (PC) system and/or game console, logically separated but co-located within the entit(ies). For example, a single entity may support a logically separate, but co-located, game server and routing server. Also, for example, a single entity may support a logically separate, but co-located personal computer and game console.

As shown, the entity capable of operating as a mobile station 10, game server 22, routing server 24, personal computer (PC) system 26 and/or game console 28 generally includes a processor 38 connected to a memory 40. The memory can comprise volatile and/or non-volatile memory, and typically stores content, data or the like. For example, the memory typically stores content transmitted from, and/or received by, the entity. Also for example, the memory typically stores client applications, instructions or the like for the processor to perform steps associated with operation of the entity in accordance with embodiments of the present invention. As explained below, for example, the memory can store client application(s) including a configuration utility, content manager and/or display manager. In this regard, when executed, the configuration utility may function to configure a source of content to receive or otherwise provide content. The content manager, when executed, may function to manage the receipt of content from the source, and/or the use of content received from the source. And the display manager may function to manage presentation of content received from the source. As described herein, the client application(s) each comprise software operated by the respective entities. It should be understood, however, that any one or more of the client applications described herein can alternatively comprise firmware or hardware, without departing from the spirit and scope of the present invention.

In addition to the memory 40, the processor 38 can also be connected to at least one interface or other means for displaying, transmitting and/or receiving data, content or the like. In this regard, the interface(s) can include at least one communication interface 42 or other means for transmitting and/or receiving data, content or the like, as well as at least one user interface that can include a display 44 and/or a user input interface 46. The user input interface, in turn, can comprise any of a number of devices allowing the entity to receive data from a user, such as a keypad, a touch display, a joystick or other input device.

Reference is now made to FIG. 3, which illustrates one type of mobile station 10, a mobile telephone, which would benefit from embodiments of the present invention. It should be understood, however, that the mobile station illustrated and hereinafter described is merely illustrative of one type of mobile station that would benefit from the present invention and, therefore, should not be taken to limit the scope of the present invention. While several embodiments of the mobile station are illustrated and will be hereinafter described for purposes of example, other types of mobile stations, such as portable digital assistants (PDAs), pagers, laptop computers, mobile gaming devices and other types of electronic systems, can readily employ the present invention.

As shown, in addition to an antenna 14, the mobile station 10 can include a transmitter 48, receiver 50, and controller 52 or other processor that provides signals to and receives signals from the transmitter and receiver, respectively. These signals include signaling information in accordance with the air interface standard of the applicable cellular system, and also user speech and/or user generated data. In this regard, the mobile station can be capable of operating with one or more air interface standards, communication protocols, modulation types, and access types. More particularly, the mobile station can be capable of operating in accordance with any of a number of first generation (1G), second generation (2G), 2.5G and/or third-generation (3G) communication protocols or the like. For example, the mobile station may be capable of operating in accordance with 2G wireless communication protocols IS-136 (TDMA), GSM, and IS-95 (CDMA). Also, for example, the mobile station may be capable of operating in accordance with 2.5G wireless communication protocols GPRS, EDGE, or the like. Further, for example, the mobile station may be capable of operating in accordance with 3G wireless communication protocols such as UMTS network employing WCDMA radio access technology. Some NAMPS, as well as TACS, mobile stations may also benefit from the teaching of this invention, as should dual or higher mode phones (e.g., digital/analog or TDMA/CDMA/analog phones).

It is understood that the controller 52 includes the circuitry required for implementing the audio and logic functions of the mobile station 10. For example, the controller may be comprised of a digital signal processor device, a microprocessor device, and various analog-to-digital converters, digital-to-analog converters, and other support circuits. The control and signal processing functions of the mobile station are allocated between these devices according to their respective capabilities. The controller can additionally include an internal voice coder (VC) 52a, and may include an internal data modem (DM) 52b. Further, the controller may include the functionality to operate one or more client software programs such as those indicated above, which may be stored in memory (described below).

The mobile station 10 also comprises a user interface including a conventional earphone or speaker 54, a ringer 56, a microphone 58, a display 60, and a user input interface, all of which are coupled to the controller 52. Although not shown, the mobile station can include a battery for powering the various circuits that are required to operate the mobile station, as well as optionally providing mechanical vibration as a detectable output. The user input interface, which allows the mobile station to receive data, can comprise any of a number of devices allowing the mobile station to receive data, such as a keypad 52, a touch display (not shown), a joystick (not shown) or other input device. In embodiments including a keypad, the keypad includes the conventional numeric (0-9) and related keys (#, *), and other keys used for operating the mobile station.

The mobile station 10 can also include one or more means for sharing and/or obtaining data. For example, the mobile station can include a short-range radio frequency (RF) transceiver or interrogator 64 so that data can be shared with and/or obtained from electronic devices in accordance with RF techniques. The mobile station can additionally, or alternatively, include other short-range transceivers, such as, for example an infrared (IR) transceiver 66, and/or a Bluetooth (BT) transceiver 68 operating using Bluetooth brand wireless technology developed by the Bluetooth Special Interest Group. The mobile station can therefore additionally or alternatively be capable of transmitting data to and/or receiving data from electronic devices in accordance with such techniques. Although not shown, the mobile station can additionally or alternatively be capable of transmitting and/or receiving data from electronic devices according to a number of different wireless networking techniques, including WLAN techniques such as IEEE 802.11 techniques or the like.

The mobile station 10 can further include memory, such as a subscriber identity module (SIM) 70, a removable user identity module (R-UIM) or the like, which typically stores information elements related to a mobile subscriber. In addition to the SIM, the mobile station can include other removable and/or fixed memory. In this regard, the mobile station can include volatile memory 72, such as volatile Random Access Memory (RAM) including a cache area for the temporary storage of data. The mobile station can also include other non-volatile memory 74, which can be embedded and/or may be removable. The non-volatile memory can additionally or alternatively comprise an EEPROM, flash memory or the like. The memories can store any of a number of software applications, instructions, pieces of information, and data, used by the mobile station to implement the functions of the mobile station.

As will be appreciated, a number of the entities of the system of FIG. 1 can be configured in any of a number of different architectures to perform any of a number of functions. For example, the entities of the system of FIG. 1 can be configured in a centralized client-server architecture, decentralized architecture and/or proxy architecture. Additionally or alternatively, for example, the entities of the system of FIG. 1 can be configured in an architecture given in the Scalable Network Application Package (SNAP) (formerly Sega Network Application Package) provided by Nokia Corporation for applications such as in the context of gaming.

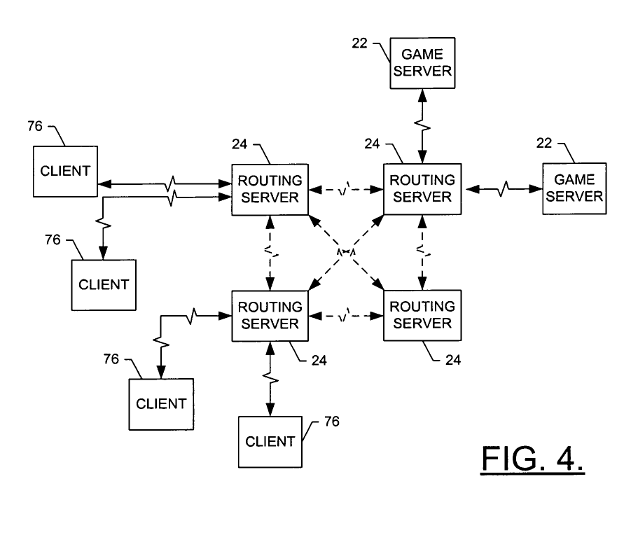

More particularly, as shown in FIG. 4, for example, one or more mobile stations, PC systems and/or game consoles may operate as clients 76 in a gaming architecture that also includes one or more game servers 22 and routing servers 24. In the illustrated architecture, similar to a conventional client-server architecture, the game servers operate games and maintain the state of those games. The clients, then, operate client-side game applications that communicate with the game servers to repeatedly change the game state of the games operated and maintained by the game servers to thereby play those games.

Also in the illustrated architecture, the clients 76 are coupled to routing servers 24 which, in turn, are coupled to the game servers 22. Thus, the routing servers route data packets between one or more clients 76 and the game servers 22, and/or other clients, to facilitate the operation of each entity in the architecture. As shown, the routing servers can be coupled between groups of clients and one or more routing servers, directly or indirectly via one or more other routing servers. In this regard, one or more routing servers can also be coupled to other routing servers such that the routing servers can also be coupled between one or more clients and one or more groups of other clients, such as groups of clients coupled to other routing servers.

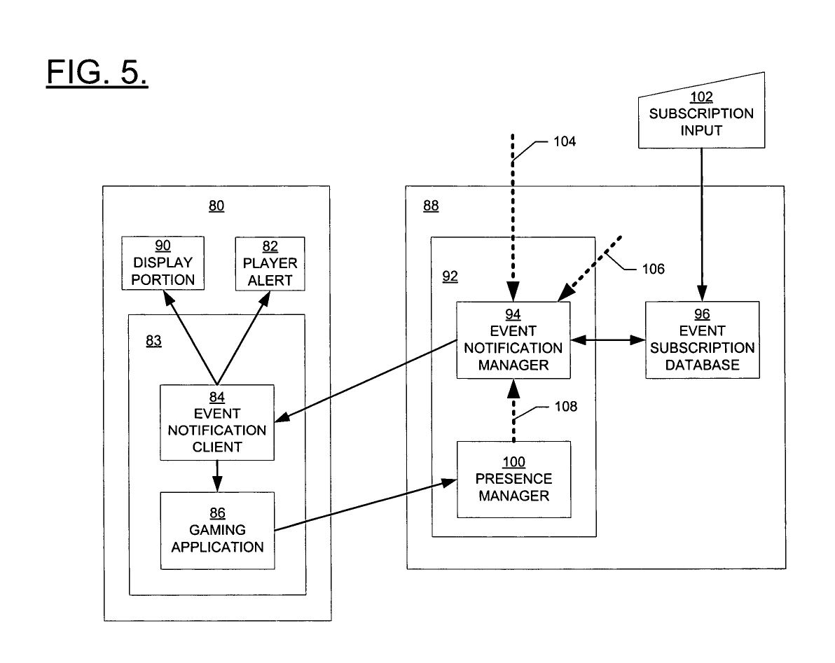

Referring now to FIG. 5, a schematic block diagram of a game event notification system is shown, in accordance with one embodiment of the present invention. A game notification system allows a player of a multiplayer game to receive notification of events while the player is not playing the game. The game event notification system comprises gaming device 80 and game server 88. The gaming device 80 has a processor 83, which in turn has an event notification client 84 and a gaming application 86. The game server 88 has a processor 92 and an event subscription database 96. Processor 92 of game server 88 has an event notification manager 94 and a presence manager 100. Relating FIG. 5 to the overall system of FIG. 1, it should be appreciated that the gaming device 80 could be the mobile station 10, game console 28, or personal computer 26 of FIG. 1. It should be appreciated that the gaming device 80 and the game server 88 of FIG. 5 are not complete representations of all features and components of gaming devices and gaming systems. Only those features and components that are relevant to the game event notification system are illustrated.

The game event notification system allows a player to subscribe to the notification system. FIG. 5 illustrates the player's subscription preferences being input 102 and stored in the event subscription database 96. In one embodiment, the subscription preferences may be input from the gaming device. Alternatively, the subscription preferences may be input from a personal computer communicating over a network, such as the Internet.

The processor 92 of game server 88 has an event notification manager 94 which monitors events within or external to the game server. As shown in FIG. 5, event 104 originates from external to the game server 88, event 106 originates in the game server 88, and event 108 originates in the presence manager 100. For example, event 108 may originate when a particular other player connects to the game server, begins playing a particular game, or changes the player's presence status. Event 106 may originate when the status of a persistent game changes. The specifics of which events trigger a notification to a given player may be based on the player's subscription preferences or may otherwise be predefined by the system designer, and are generally stored by the event subscription database 96.

When a particular event occurs, the event notification manager 94 communicates with the event subscription database 96 to determine which gaming device(s) belonging to which player(s) should receive notification of the event. After the event notification manager 94 determines which players to notify, the event notification manager 94 transmits predefined messages to the appropriate gaming device(s) 80. The messages are received by the event notification client 84 on the processor 83 of gaming device 80, which then displays the message on a display portion 90 of the gaming device. Depending upon preferences set by the player and the capabilities of the device, the gaming device 80, in addition to or instead of providing a visual display of the message, may activate a player alert 82. The player alert 82 may be an audio alert, such as beeping or polyphonic tones, or may provide a tactile alert, such as vibration.

When the event notification client 84 of the gaming device 80 receives the notification, in addition to displaying the message and providing an alert, the event notification client may also interface with the gaming application 86. The event notification client 84 may cause the gaming application 86 to start, either automatically or upon confirmation by the player, and may start a specific game that was the subject of the notification. In FIG. 5, event notification client 84 and gaming application 86 are represented separately. In one embodiment of the invention, event notification client 84 and gaming application 86 may be separate software programs which are capable of executing separately on the gaming device 80. In another embodiment, both event notification client 84 and gaming application 86 may together comprise the client-side gaming application. In this embodiment, the entire client-side gaming application (i.e., both event notification client 84 and gaming application 86) would typically execute when a player is playing the multiplayer game. However, when the player is not playing the multiplayer game, only the event notification client portion of the client-side gaming application (i.e., the portion that maintains the minimal communication connection) would typically be executing.

It should also be appreciated that communication between the event notification client 84 and the game server 88 may occasionally be interrupted for various reasons. When the communication is interrupted, the event notifications may be queued at the game server and delivered to the gaming device 80 when the communication is reestablished.

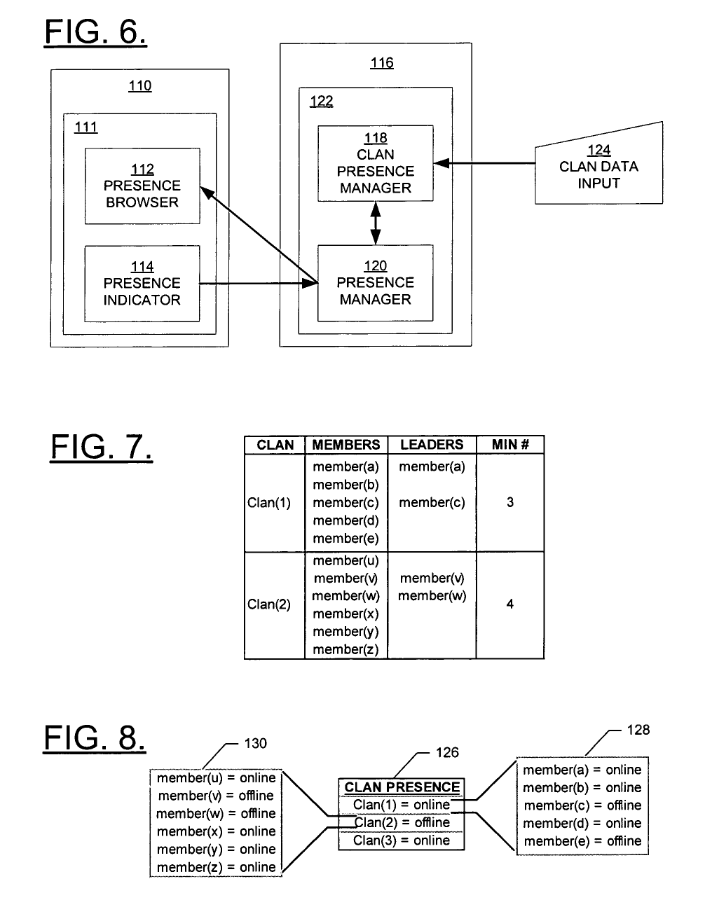

Referring now to FIG. 6, a schematic block diagram of a clan presence system is shown, in accordance with one embodiment of the present invention. As discussed above, the clan presence system allows a player to quickly determine the presence status of the player's gaming clan, or of other clans, without determining the status of each clan member individually. The clan presence system comprises a clan presence manager 118 which interfaces with a presence manager 120, both of which are elements of or at least in communication with the processor 122 of game server 116. The clan presence system and, in particular, the presence manager 120 are also in communication with a presence indicator 114 and a presence browser 112 of processor 111 of the gaming device 110. It should be appreciated that the gaming device 110 and the game server 116 of FIG. 6 are not complete representations of all features and components of gaming devices and gaming systems. Only those features and components that are relevant to the clan presence system are illustrated. It should also be appreciated that presence browser 112 and presence indicator 114 may be implemented as separate software modules executing on processor 111, or may be incorporated within a larger software module, such as a gaming application.

In one embodiment, a member of a clan who is designated as a clan administrator inputs clan data 124 to the clan presence manager 118. This clan data contains presence rules for the clan, as discussed in detail below. In alternative embodiments, multiple members, or all members, of a clan may be permitted to input clan data to the clan presence manager 118.

The presence manager 120 monitors the presence status of all players, whether a member of a clan or not. The clan presence manager 118 communicates with the presence manager 120 to monitor the presence status of all players that are clan members. The clan presence manager 118 determines the presence status of each clan, based on the presence status of the clan members and the clan presence rule for each clan. The clan presence manager 118 then provides the clan presence status for each clan to the presence manager 120. The presence manager 120 communicates with the presence browser 112 on the processor 11 of gaming device 110, such that the presence status of any player or any clan may be communicated to the gaming device and displayed for the player to view.

Referring now to FIG. 7, an illustration of clan data input to a clan presence system is shown, in accordance with one embodiment of the present invention. The presence rules may include which players are members of the clan, which players are eligible to be leader of the clan during gaming, and what minimum number of clan members is required to play a particular game. For example, in FIG. 7, clan data is shown for two clans, Clan(1) and Clan(2). The members of each clan are listed in the MEMBERS column of the clan data. Clan(1) has five members, member(a) through member(e), and Clan(2) has six members, member(u) through member(z). The members of each clan who are eligible to be clan leader are listed in the LEADERS column. Clan(1) has two members eligible to be clan leader, member(a) and member(c), and Clan(2) has two members eligible to be clan leader, member(v) and member(w). The minimum number of clan members who must be online in order for the clan to be considered online is listed in the MIN# column. Clan(1) requires that at least three of its members be online before the clan can be considered online. Clan(1) requires that at least four of its members be online before the clan can be considered online. The clan presence conditions may also include a requirement that a minimum number of clan members be within a particular vicinity or connected via a particular bearer service, although these conditions are not shown in FIG. 7.

Referring now to FIG. 8, an illustration of clan presence information output to a gaming device is shown, in accordance with one embodiment of the present invention. In FIG. 8, a clan presence status is shown in 126 for Clan(1) (“online”), Clan(2) (“offline”), and Clan(3) (“online”). A breakdown of the individual presence status for members of Clan(1) and Clan(2) is shown in 128 and 130, respectively. This individual presence status shown in 128 and 130 forms the basis for reporting the clan presence status of Clan(1) and Clan(2) in 126, according to the rules in the clan presence server as shown in FIG. 7. As shown in FIG. 8, four members of Clan(1) are online (member(a), member(b), member(d), and member(e)). This meets the minimum number of members set in the MIN# column of FIG. 7, and a required leader (member(a)) is online, as specified in the LEADERS column of FIG. 7. Because Clan(1) meets the minimum number of members required and has a designated clan leader online, Clan(1)'s presence status is shown as “online” in 126. As shown in FIG. 8, four members of Clan(2) are online (member(u), member(x), member(y), and member(z)). This meets the minimum number of members set in the MIN# column of FIG. 7. However, only member(v) and member(w) are designated leaders of Clan(2) and neither of these members is online. Therefore, because Clan(2) does not have a designated clan leader online, Clan(2)'s presence status is shown as “offline” in 126.

In one embodiment of the present invention, a player may view either the presence status of one or more clans at the clan level, or the player may select a specific clan and thereby view the presence status of all members of that selected clan. The clan presence status may be presented to a player in a variety of ways. For example, a player may choose to only view the status of clans of which the player is a member, or the player may view a list of all clans with the player's clans displayed at the top of the list.

Although shown as separate components, it should be appreciated that some or all of the event notification manager 94, the event subscription database 96, and the presence manager 100 of FIG. 5 may be combined into a single component, such as a server. It should also be appreciated that some or all of the clan presence manager 118 and the presence manager 120 of FIG. 6 may be combined into a single server.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A system for determining presence status of a clan in a multiplayer game, the system comprising:
a game server capable of executing a game application, the game application being capable of operating a multiplayer game; and
a plurality of clients capable of communicating with the game server across at least one network to play the multiplayer game, wherein the plurality of clients are each associated with a respective presence status, and wherein the plurality of clients are each members of a clan;
wherein the game server determines a presence status of the clan based on the presence status of the plurality of clients.

2. The system of claim 1, wherein the game server monitors the presence status of the plurality of clients and determines the presence status of the clan when the presence status of at least one of the plurality of clients changes.

3. The system of claim 1, wherein the game server is responsive to a clan rule to determine the presence status of the clan.

4. A game server for determining presence status of a clan in a multiplayer game, the game server comprising:
a processor capable of executing a game application, the game application being capable of operating a multiplayer game played by a plurality of clients that are each associated with a respective presence status, and wherein the plurality of clients are each members of a clan;
wherein the processor determines a presence status of the clan based on the presence status of the plurality of clients.

5. The game server of claim 4, wherein the processor monitors the presence status of the plurality of clients and determines the presence status of the clan when the presence status of at least one of the plurality of clients changes.

6. The game server of claim 5, wherein the presence status of the plurality of clients and the presence status of the clan is selected from the group comprising online and offline.

7. The game server of claim 6, wherein the processor is responsive to a clan rule to determine the presence status of the clan.

8. The game server of claim 7, wherein the clan rule establishes a minimum number of the plurality of clients whose presence status must be online for the presence status of the clan to be online.

9. The game server of claim 7, wherein the clan rule establishes which of the plurality of clients are capable of being a clan leader such that the clan leader must have a presence status of online for the presence status of the clan to be online.

10. A terminal for viewing presence status of a clan in a multiplayer game, the terminal comprising:
a processor capable of executing a client-side game application and capable of communicating with a game server across at least one network to play a multiplayer game with a plurality of clients;
wherein the plurality of clients are each associated with a respective presence status; wherein the plurality of clients are each members of a clan; and wherein the processor is capable of receiving a presence status of the clan from the game server based on the presence status of the plurality of clients.

11. The terminal of claim 10, wherein the processor is capable of receiving a changed presence status of the clan from the game server when the presence status of at least one of the plurality of clients changes.

12. The terminal of claim 11, wherein the presence status of the plurality of clients and the presence status of the clan is selected from the group comprising online and offline.

13. The terminal of claim 12, wherein the game server is responsive to a clan rule to determine the presence status of the clan.

14. The terminal of claim 13, wherein the clan rule establishes a minimum number of the plurality of clients whose presence status must be online for the presence status of the clan to be online.

15. The terminal of claim 13, wherein the clan rule establishes which of the plurality of clients are capable of being a clan leader such that the clan leader must have a presence status of online for the presence status of the clan to be online.

16. A method for determining presence status of a clan in a multiplayer game, the method comprising:
executing a server-side game application that operates a multiplayer game that is capable of being played by a plurality of clients, the plurality of clients each being members of a clan;
determining a presence status of the clan based on a presence status of the plurality of clients; and
communicating the presence status of the clan to at least one of the plurality of clients.

17. The method of claim 16, further comprising:
monitoring the presence status of the plurality of clients; and
determining the presence status of the clan when the presence status of at least one of the plurality of clients changes.

18. The method of claim 17, wherein the presence status of the plurality of clients and the presence status of the clan is selected from the group comprising online and offline.

19. The method of claim 18, further comprising establishing a clan rule such that the clan rule is used to determine the presence status of the clan.

20. The method of claim 19, wherein establishing a clan rule comprises establishing a minimum number of the plurality of clients whose presence status must be online for the presence status of the clan to be online.

21. The method of claim 19, wherein the clan rule establishes which of the plurality of clients are capable of being a clan leader such that the clan leader must have a presence status of online for the presence status of the clan to be online.
